(19) United States
(12) Patent Application Publication
(10) Pub. No.: US 2017/0163166 A1
(43) Pub. Date: Jun. 8, 2017

(54) AC-AC VOLTAGE TRANSFORMATION DEVICE AND VOLTAGE TRANSFORMATION METHOD THEREOF

(71) Applicant: HEP TECH CO., LTD., Taichung City (TW)

(72) Inventors: CHING-TSAI PAN, Hsinchu City (TW); PO-YEN CHEN, Taipei City (TW); TA-SHENG HUNG, Taichung City (TW)

(21) Appl. No.: 15/039,171

(22) PCT Filed: Oct. 14, 2014
(86) PCT No.: PCT/CN2014/000907

§ 371 Date: May 25, 2016

(30) Foreign Application Priority Data
Nov. 29, 2013 (CN) 201310632831.6

(51) Int. Cl. H02M 5/458; H02M 1/08

(52) U.S. Cl. CPC H02M 5/458; H02M 1/08; H02M 2001/0003

(57) ABSTRACT

An AC-AC voltage transformation device is provide, which includes: a first diode (D1), its positive electrode connects to one end of a (AC) power source; a second diode (D2), its negative electrode connects to the joint of D1 and the power source; a third diode (D3), its positive electrode connects to the other end of the power source; a fourth diode (D4), its negative electrode connects to the joint of D3 and the power source, and its positive electrode connects to the positive electrode of D2; a transformer (10), its primary side has a first coil (N1) and a second coil (N2), wherein N1 connects to the negative electrode of D1, and N2 connects to the negative electrode of D3, and its secondary side connects to a load; an electrode switch (SW), one end thereof connects to the joint of D2 and D4, and the other end thereof connects to the joint of N1 and N2.

### TECHNICAL FIELD

The present disclosure relates to power conversion, in particular to an AC-AC voltage transformation device and the voltage transformation method thereof.

### BACKGROUND

The voltage transformation of a conventional transformer usually depends on the turn ratio of the coil of the secondary side to the coil of the primary side; accordingly, the conventional transformer is of large size and high cost, has no protection circuit, and not suitable for the application of the AC-AC voltage transformation. So as to improve the above shortcomings, an electronic AC-AC voltage transformation device, as shown in FIG. 1, is developed; the AC power source stores the electricity into the capacitors C1, C2; when the active switch S1 is turned on, the electricity energy stored in the capacitor C1 passes through the active switch S1 and transformed by the transformer 40, and then transmitted to the load 400; when the active switch S2 is turned on, the electricity energy stored in the capacitor C2 passes through the active switch S2, and transformed by the transformer 40, and then transmitted to the load 400; in this way, the transformed AC electricity energy can be supplied to the load 400 via the above switching operations.

However, in order to make the above design achieve better energy buffer effect, it is usually necessary to adopt expensive capacitors with high capacitance as the capacitors C1, C2, which will not only increase the size, but also will increase the cost; moreover, the number of the charge/discharge times of the capacitor is limited, so the AC-AC voltage transformation device cannot have longer service life. In addition, the safety of the circuit design of the above AC-AC voltage transformation device is also in double; if the active switches S1, S2 are turned on at the same time, the internal circuit will be short-circuited and then burned.

Accordingly, the above currently available AC-AC voltage transformation device and the voltage transformation method thereof are still inconvenient and have defects in product structure, method and usage, which need to be further improved

### SUMMARY

In view of above, the object of the present invention is to provide an AC-AC voltage transformation device and the voltage transformation thereof to overcome the defects of the currently available AC-AC voltage transformation device and the voltage transformation thereof, which are not only safe and of long service, but also simple in operation.

The object and the solution for solving the technical problems of the present invention are realized by adopting the following technical schemes. The present invention provides an AC-AC voltage transformation device used for transforming the voltage of the electricity energy of an AC power source and supplying the voltage of the AC power source to a load, and the AC power source has a first terminal and a second terminal; the AC-AC voltage transformation device includes a first diode, a second diode, a third diode, a fourth diode, a transformer, an electronic switch and a control module. More specifically, the positive electrode of the first diode is connected to the first terminal of the AC power source. The negative electrode of the second diode is connected to the joint of the positive electrode of the first diode and the first terminal of the AC power source. The positive electrode of the third diode is connected to the second terminal of the AC power source. The negative electrode of the fourth diode is connected to the joint of the positive electrode of the third diode and the second terminal of the AC power source, and the positive electrode thereof is connected to the positive electrode of the second diode. The transformer has a primary side and a secondary side, wherein the primary side has a first coil and a second coil; one end of the first coil is connected to one end of the second coil, the other end of the first coil is connected to the negative electrode of the first diode, and the other end of the second coil is connected to the negative electrode of the third diode; the secondary side is connected to the load. One end of the electronic switch is connected to the joint of the positive electrode of the second diode and the positive electrode of the fourth diode, and the other end thereof is connected to the joint of the first coil and the second coil. The control module is electrically connected to the electronic switch to turn on or turn off the electronic switch.

The object and the solution for solving the technical problems of the present invention can be further realized by adopting the following technical measures.

Regarding the AC-AC voltage transformation device, the control module includes a feedback control circuit and a PWM (Pulse Width Modulation) circuit; the feedback control circuit includes a voltage detection terminal, a current detection terminal and an output terminal; the voltage detection terminal and the current detection terminal are electrically connected to the primary side of the transformer to detect the voltage and the current of the primary side of the transformer and make the output terminal output the signal corresponding to the voltage and the current of the primary side; one end of the PWM circuit is electrically connected to the output terminal, and the other end thereof is electrically connected to the electronic switch to receive the signal outputted by the output terminal and generate the PWM signal corresponding to the signal outputted by the output terminal so as to turn on or turn off the electronic switch.

Regarding the AC-AC voltage transformation device, the control module includes a feedback control circuit and a PWM (Pulse Width Modulation) circuit; the feedback control circuit includes a voltage detection terminal, a current detection terminal and an output terminal; the voltage detection terminal and the current detection terminal are electrically connected to the secondary side of the transformer to detect the voltage and the current of the secondary side of the transformer and make the output terminal output the signal corresponding to the voltage and the current of the secondary side; one end of the PWM circuit is electrically connected to the output terminal, and the other end thereof is electrically connected to the electronic switch to receive the signal outputted by the output terminal and generate the PWM signal corresponding to the signal outputted by the output terminal so as to turn on or turn off the electronic switch.

Regarding the AC-AC voltage transformation device, the primary side of the transformer further includes a third coil, and the control module includes a feedback control circuit and a ringing choke converter (RCC) circuit; the feedback control circuit has a voltage detection terminal, a current detection terminal and an output terminal; the voltage detection terminal and the current detection terminal are electrically connected to the primary side of the transformer to detect the voltage and the current of the primary side of the transformer and make the output terminal output the signal corresponding to the voltage and the current of the primary side; the ringing choke converter circuit is electrically connected to the third coil, the output terminal and the electronic switch to receive the signal outputted by the output terminal so as to turn on or turn off the electronic switch.

Regarding the AC-AC voltage transformation device, the primary side of the transformer further includes a third coil, and the control module includes a feedback control circuit and a ringing choke converter (RCC) circuit; the feedback control circuit has a voltage detection terminal, a current detection terminal and an output terminal; the voltage detection terminal and the current detection terminal are electrically connected to the secondary side of the transformer to detect the voltage and the current of the secondary side of the transformer and make the output terminal output the signal corresponding to the voltage and the current of the secondary side; the ringing choke converter circuit is electrically connected to the third coil, the output terminal and the electronic switch to receive the signal outputted by the output terminal so as to turn on or turn off the electronic switch. The object and the solution for solving the technical problems of the present invention can be further realized by adopting the following technical schemes. The present invention provides a voltage transformation method of the AC-AC voltage transformation device, which includes the following steps:

A. turning on the electronic switch to make the electricity energy of the AC power source pass through the first diode, the first coil, the electronic switch and the fourth diode, or pass through the third diode, the second coil, the electronic switch and the second diode, whereby the AC power source is able to output the electricity energy to the load from the secondary side via the transformer;

B. turning off the electronic switch to disconnect the AC power source from the primary side so as to make the secondary side of the transformer stop outputting the electricity energy to the load.

The object and the solution for solving the technical problems of the present invention can be further realized by adopting the following technical measures.

Regarding the voltage transformation method, wherein the method further includes a step after the step B, and the step is to repeat executing the step A to the step B.

Regarding the voltage transformation method, wherein when the electricity energy of the AC power source is in the positive half cycle during the step A, the electricity energy passes through the first diode, the first coil, the electronic switch and the fourth diode; when the electricity energy of the AC power source is in the negative half cycle, the electricity energy passes through the third diode, the second coil, the electronic switch and the second diode.

Compared with prior art, the present invention has obvious advantages and beneficial effects. By means of the above technical schemes, the AC-AC voltage transformation and the voltage transformation method thereof in accordance with the present invention have at least the following advantages and beneficial effects: via the above structure design and method design, the present invention can be safe, of long service life and simple in operation.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1 is a circuit structure diagram of a currently available AC-AC voltage transformation device.

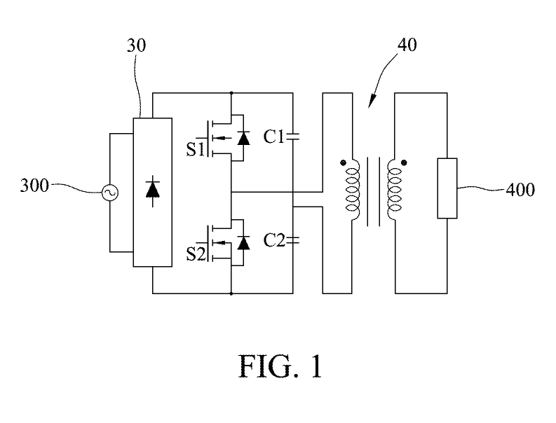

FIG. 2 is a circuit structure diagram of a first preferred embodiment in accordance with the present invention.

FIG. 3 is an equivalent circuit diagram of the positive half cycle

FIG. 4 is an equivalent circuit diagram of the negative half cycle.

FIG. 5 is a circuit structure diagram of a second preferred embodiment in accordance with the present invention.

FIG. 6 is a circuit structure diagram of a third preferred embodiment in accordance with the present invention.

FIG. 7 is a circuit structure diagram of a fourth preferred embodiment in accordance with the present invention.

### DETAILED DESCRIPTION

The technical content of the present invention will become apparent by the detailed description of the following embodiments and the illustration of related drawings as follows.

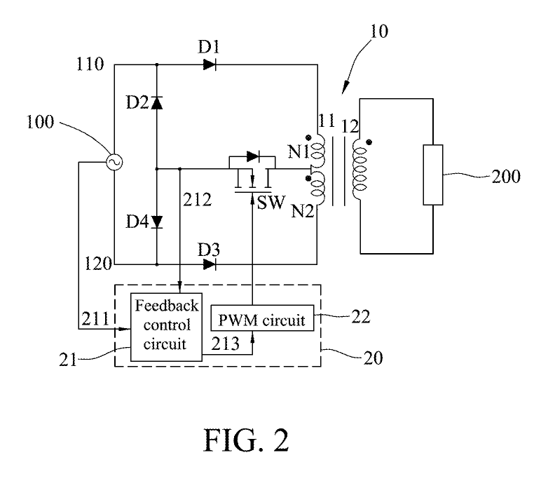

Please refer to FIG. 2, which is an AC-AC voltage transformation device of a preferred embodiment used for transforming the voltage of the electricity energy of an AC power source 100 and supplying the voltage to a load 200, and the AC power source 100 has a first terminal 110 and a second terminal 120; the AC-AC voltage transformation device includes 4 diodes (the first diode D1˜the fourth diode D4), a transformer 10, an electronic switch SW and a control module 20. More specifically:

The positive electrode of the first diode D1 is connected to the first terminal 110 of the AC power source 100.

The negative electrode of the second diode D2 is connected to the joint of the positive electrode of the first diode D1 and the first terminal 110 of the AC power source 100.

The positive electrode of the third diode D3 is connected to the second terminal 120 of the AC power source 100.

The negative electrode of the fourth diode D4 is connected to the joint of the positive electrode of the third diode D3 and the second terminal 120 of the AC power source 100, and the positive electrode thereof is connected to the positive electrode of the second diode D2.

The transformer 10 has a primary side 11 and a secondary side 12, wherein the primary side 11 has a first coil N1 and a second coil N2; one end of the first coil N1 is connected to one end of the second coil N2, the other end of the first coil N1 is connected to the negative electrode of the first diode D1, and the other end of the second coil N2 is connected to the negative electrode of the third diode D3; the secondary side 12 is connected to the load 200.

One end of the electronic switch SW is connected to the joint of the positive electrode of the second diode D2, the positive electrode of the fourth diode D4, and the other end thereof is connected to the joint of the first coil N1 and the second coil N2, and can be controlled to be turned on or turned off.

The control module 20 is electrically connected to the electronic switch SW to turn on or turn off the electronic switch SW. In the embodiment, the control module 20 includes a feedback control circuit 21 and a PWM (Pulse Width Modulation) circuit 22; the feedback control circuit 21 includes a voltage detection terminal 211, a current detection terminal 212 and an output terminal 213; the voltage detection terminal 211 and the current detection terminal 212 are electrically connected to the primary side 11 of the transformer 10 to detect the voltage and the current of the primary side 11 of the transformer 10 and make the output terminal 213 output the signal corresponding to the voltage and the current of the primary side. In the embodiment, the voltage detection terminal 211 is connected to the AC power source 100 to detect the voltage of the primary side 11, and the current detection terminal 212 is connected to the joint of the electronic switch SW, the second diode D2 and the fourth diode D4 to detect the current provided for the primary side 11. Of course, in practical implementation, which may be connected to other positions to achieve the same object. One end of the PWM circuit 22 is electrically connected to the output terminal 213, and the other end thereof is electrically connected to the electronic switch SW to receive the signal outputted by the output terminal 213 and generate the corresponding PWM signal for the electronic switch SW so as to turn on or turn off the electronic switch.

In the embodiment, the specifications of the input voltage, the output voltage, the switching frequency of the electronic switch SW and the load 200 are as shown in following Table 1:

TABLE 1

| | | |
|---|---|---|
| Input voltage Vin | 220 | Vᵣₘₛ |
| Output voltage Vout | 24 | V |
| Switching frequency | 100 | KHz |
| Load resistance | 2.4 | Ω |

The objects of the power factor correction and voltage transformation can be achieved by integrating the above structure design and specification with the following method; the method includes the following steps:

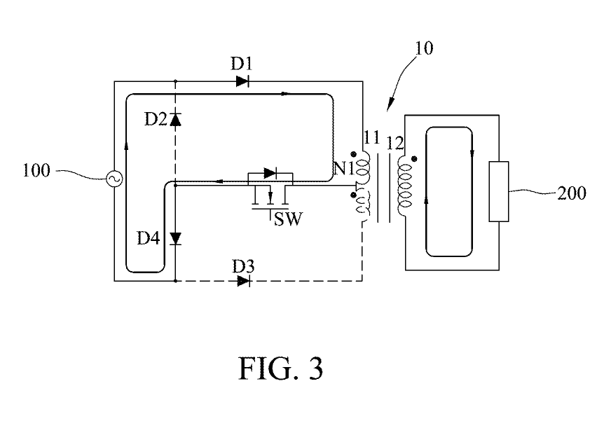

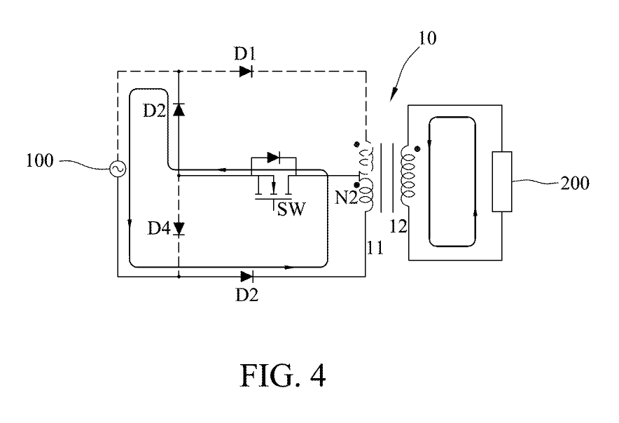

A. please refer to FIG. 3 and FIG. 4, turning on the electronic switch SW for a first predetermined time to make the electricity energy of the AC power source 100 pass through the first diode D1, the first coil N1, the electronic switch SW and the fourth diode D4 during the electricity energy of the AC power source 100 is in the positive half cycle, whereby the AC power source 100 is able to output the electricity energy to the load 200 from the secondary side 12 via the transformer 10 (as shown in FIG. 3). When the electricity energy of the AC power source 100 is in the negative half cycle, the electricity energy of the AC power source 100 pass through the third diode D3, the second coil N2, the electronic switch SW and the second diode D2, whereby the AC power source 100 is able to output the electricity energy to the load 200 from the secondary side 12 via the transformer 10 (as shown in FIG. 4).

B. turning off the electronic switch SW for a second predetermined time to disconnect the AC power source 100 from the primary side 11 so as to make the secondary side 12 of the transformer 10 stop outputting the electricity energy to the load 200.

In addition, after each of the step A˜step B is executed for one time, it means one operation cycle is finished. Thus, when the AC-AC voltage transformation device keeps being in operation, the step A˜step B will be repeatedly executed after the step B until the AC-AC voltage transformation device is turned off.

Accordingly, by means of the above design, the first predetermined time and the second predetermined time can be adjusted to achieve the objects of changing the voltage outputted to the load 200 and increase the power factor. Besides, the whole circuit does not need to use capacitors, and can be controlled only via the electronic switch SW, which is not only of long service and simple in operation, but also can solve the problem that the currently available transformation device tends to be damaged due to short-circuit.

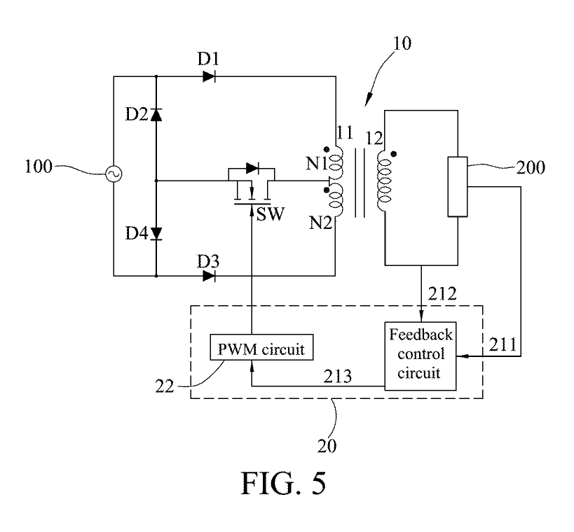

Moreover, the feedback control circuit 21 of the control module 20 can just like which shown in FIG. 5; the voltage detection terminal 211 and the current detection terminal 212 are electrically connected to the secondary side 12 of the transformer 10 so as to detect the voltage and the current of the secondary side 12 of the transformer 10, which can more precisely control the PWM circuit 22 to output the corresponding PWM signal for turning on or turning off the electronic switch SW.

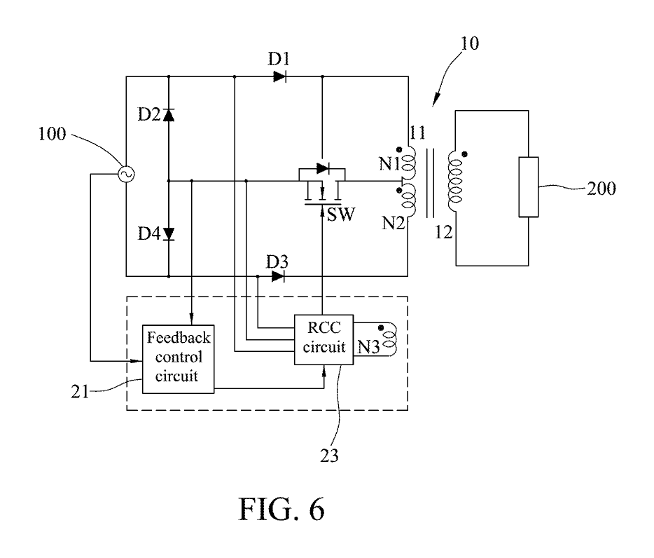

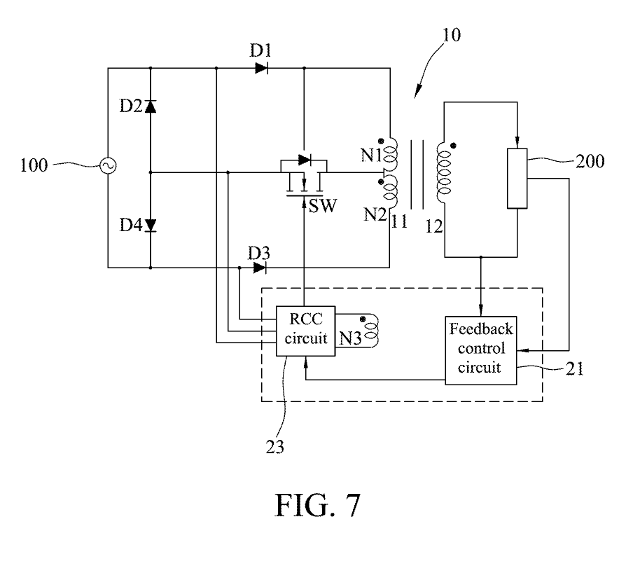

Furthermore, FIG. 6 and FIG. 7 show another structure in addition to using the PWM circuit 22 to control the electronic switch SW to be turned on or turned off; when the primary side 11 of the transformer 10 includes a third coil N3, and third coil N3 may be used to design the ringing coke converter (RCC) circuit 23 to replace the aforementioned PWM circuit 21 so as to turn on or turn off the electronic switch SW; similarly, in this structure, the feedback control circuit 22 can be electrically to the primary side 11 (as shown in FIG. 6) or the secondary side 12 (as shown in FIG. 7) according to the requirements for detecting the voltage and the current so as to achieve the object of the previous embodiment.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An AC-AC voltage transformation device, used for transforming a voltage of an electricity energy of an AC power source and supplying the voltage of the AC power source to a load, and the AC power source having a first terminal and a second terminal; the AC-AC voltage transformation device being characterized in comprising:
a first diode, a positive electrode of the first diode being connected to the first terminal of the AC power source;
a second diode, a negative electrode of the second diode being connected to a joint of the positive electrode of the first diode and the first terminal of the AC power source;
a third diode, a positive electrode of the third diode being connected to the second terminal of the AC power source;
a fourth diode, a negative electrode of the fourth diode being connected to a joint of the positive electrode of the third diode and the second terminal of the AC power source, and a positive electrode of the fourth diode being connected to a positive electrode of the second diode;
a transformer, having a primary side and a secondary side, the primary side having a first coil and a second coil, one end of the first coil being connected to one end of the second coil, the other end of the first coil being connected to a negative electrode of the first diode, and the other end of the second coil being connected to a negative electrode of the third diode; the secondary side being connected to the load;
an electronic switch, one end of the electronic switch being connected to a joint of the positive electrode of the second diode and the positive electrode of the fourth diode, and the other end of the electronic switch being connected to a joint of the first coil and the second coil; and
a control module, being electrically connected to the electronic switch to turn on or turn off the electronic switch.

2. The AC-AC voltage transformation device of claim 1, characterized in that the control module comprises a feedback control circuit and a PWM circuit; the feedback control circuit comprises a voltage detection terminal, a current detection terminal and an output terminal; the voltage detection terminal and the current detection terminal are electrically connected to the primary side of the transformer to detect a voltage and a current of the primary side of the transformer and make the output terminal output a signal corresponding to the voltage and the current of the primary side; one end of the PWM circuit is electrically connected to the output terminal, and the other end of the PWM circuit is electrically connected to the electronic switch to receive the signal outputted by the output terminal and generate a PWM signal corresponding to the signal outputted by the output terminal so as to turn on or turn off the electronic switch.

3. The AC-AC voltage transformation device of claim 1, characterized in that the control module comprises a feedback control circuit and a PWM circuit; the feedback control circuit comprises a voltage detection terminal, a current detection terminal and an output terminal; the voltage detection terminal and the current detection terminal are electrically connected to the secondary side of the transformer to detect a voltage and a current of the secondary side of the transformer and make the output terminal output a signal corresponding to the voltage and the current of the secondary side; one end of the PWM circuit is electrically connected to the output terminal, and the other end of the PWM circuit is electrically connected to the electronic switch to receive the signal outputted by the output terminal and generate a PWM signal corresponding to the signal outputted by the output terminal so as to turn on or turn off the electronic switch.

4. The AC-AC voltage transformation device of claim 1, characterized in that the primary side of the transformer further comprises a third coil, and the control module comprises a feedback control circuit and a ringing choke converter circuit; the feedback control circuit has a voltage detection terminal, a current detection terminal and an output terminal; the voltage detection terminal and the current detection terminal are electrically connected to the primary side of the transformer to detect a voltage and a current of the primary side of the transformer and make the output terminal output a signal corresponding to the voltage and the current of the primary side; the ringing choke converter circuit is electrically connected to the third coil, the output terminal and the electronic switch to receive the signal outputted by the output terminal so as to turn on or turn off the electronic switch.

5. The AC-AC voltage transformation device of claim 1, characterized in that the primary side of the transformer further comprises a third coil, and the control module comprises a feedback control circuit and a ringing choke converter circuit; the feedback control circuit has a voltage detection terminal, a current detection terminal and an output terminal; the voltage detection terminal and the current detection terminal are electrically connected to the secondary side of the transformer to detect a voltage and a current of the secondary side of the transformer and make the output terminal output a signal corresponding to the voltage and the current of the secondary side; the ringing choke converter circuit is electrically connected to the third coil, the output terminal and the electronic switch to receive the signal outputted by the output terminal so as to turn on or turn off the electronic switch.

6. A voltage transformation method of the AC-AC voltage transformation device of claim 1, characterized in comprising the following steps:
A. turning on the electronic switch to make the electricity energy of the AC power source pass through the first diode, the first coil, the electronic switch and the fourth diode, or pass through the third diode, the second coil, the electronic switch and the second diode, whereby the AC power source being able to output the electricity energy to the load from the secondary side via the transformer;
B. turning off the electronic switch to disconnect the AC power source from the primary side so as to make the secondary side of the transformer stop outputting the electricity energy to the load.

7. The voltage transformation method of claim 6, characterized in further comprising a step after the step B, and the step being to repeat executing the step A to the step B.

8. The voltage transformation method of claim 6, characterized in that when the electricity energy of the AC power source is in a positive half cycle during the step A, the electricity energy passes through the first diode, the first coil, the electronic switch and the fourth diode; when the electricity energy of the AC power source is in a negative half cycle, the electricity energy passes through the third diode, the second coil, the electronic switch and the second diode.
